(19) United States
(12) Patent Application Publication
(10) Pub. No.: US 2010/0199174 A1
(43) Pub. Date: Aug. 5, 2010

(54) EXTENSIBLE FONT FILE LOADING

(75) Inventors: MIKHAIL LEONOV, SEATTLE, WA (US); NIKLAS BORSON, LANGLEY, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/365,004

(22) Filed: Feb. 3, 2009

(51) Int. Cl. G06F 17/00

(52) U.S. Cl. 715/255

(57) ABSTRACT

Extensible font file loading systems and methods are provided. In embodiments, a font file is requested and a handle associated with a font-file stream is received, the font-file stream being associated with the requested font file. The font file is then loaded using the received font-file stream. Alternatively, the handle may be received from a font-file loader. Once loaded, the font file may be utilized to render the appropriate font, for instance, utilizing an appropriate presentation component (e.g., a monitor) associated with a computing device.

### BACKGROUND

A major use of computing devices is to provide text editing and rendering services. There are a variety of applications configured to render text, including word processors, spreadsheet programs, website-authoring programs, and web browsers. Many of these programs include the ability for users to select particular fonts in which text may be rendered. These fonts can be included as part of the computing device in many ways, including as part of the operating system, embedded in a particular document, or as individual files or sets of data. Font loading mechanisms take data within font files and provide the data for use in rendering characters included in a document or stream of data to be rendered. This render process can provide a representation of the data, using one or more chosen fonts, for presentation to a user. For example, the fonts could be used in the rendering of data for display on a monitor and/or for output to a printer.

### SUMMARY

Embodiments of the present invention are related to extensible font file loading. In embodiments, a font file is requested and a handle associated with a font-file stream is received, the font-file stream being associated with the requested font file. The font file is then loaded using the received font-file stream. According to one embodiment of the invention, a font-file key can be stored in a font cache along with font-file data or higher-level font data. In accordance with another embodiment of the invention, the handle is received from a font-file loader. Once loaded, the font file may be utilized to render the appropriate font, for instance, utilizing an appropriate presentation component (e.g. a monitor) associated with a computing device.

Embodiments of the invention are defined by the claims below, not this Summary. A high-level overview of various aspects of the invention are provided here, to provide an overview of the disclosure and to introduce a selection of concepts that are further described below. This Summary is not intended to identify key features or essential features of the claimed subject matter, nor is it intended to be used as an aid in isolation to determine the scope of the claimed subject matter.

### BRIEF DESCRIPTION OF THE DRAWINGS

Illustrative embodiments of the present invention are described in detail below with reference to the attached drawing figures, which are incorporated by reference herein and wherein:

FIG. 1 depicts a block diagram of an exemplary computing environment suitable for use in implementing embodiments of the invention;

FIG. 2 is a schematic diagram depicting an exemplary loading of a font file, in accordance with an embodiment of the present invention;

FIG. 3 is a block diagram of a font-loading system, in accordance with an embodiment of the present invention;

FIG. 4 is a block diagram depicting various interfaces to font files, in accordance with some embodiments of the present invention;

FIG. 5 is a flow diagram showing a method of loading a font file, in accordance with an embodiment of the present invention;

FIG. 6 is a flow diagram showing a method of requesting a font file from a font-file-loader manager, in accordance with an embodiment of the present invention;

FIG. 7 is a flow diagram showing a method of requesting a font file from a font cache, in accordance with an embodiment of the present invention;

FIG. 8 is a flow diagram showing a method of loading a segment of a font file, in accordance with an embodiment of the present invention; and

FIG. 9 is a block diagram depicting a font-loading system, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to extensible loading of font files. Font data used by computing devices to render characters is generally stored in files. The font files may be large in size and stored in a number of locations, including on a local hard disk, on a server attached to a network, and/or embedded in an application data space. These font files can be many thousands of bytes in size, making it potentially undesirable to load the entire file into memory if only a small portion of the font file is needed. Font files can be added to the computing device by many sources, including applications, the operating system, and/or users. One can imagine that it may be desirable to have a single method of loading font data from font files, regardless of the location and format of the font file.

Font files contain data required to render various fonts. For example, a font file can include data describing how to render each printable character in the ASCII character set. If an application is only rendering a small subset of characters, then it may be possible to perform the necessary rendering using only a segment of the font file. Thus, a method of easily adding new font loaders to a computing device and allowing these new font loaders to be accessible to applications executing on the computing device increases the extensibility of the font loading system.

According to an embodiment of the invention, access to font files can be facilitated by font-file streams. A font-file stream can return segments of a font file to an application or operating system component that is tasked with rendering a font. Font-file streams can expose a common Application Programming Interface (API) for use by components of the system needing to access font files. This can allow a single interface to be used for accessing all font files in a system, regardless of the location the font files are stored (e.g., local font files, application-embedded font files, and remotely-stored font files) and the format in which the font files are stored. Additionally, font-file streams can return complete font files, segments of font files, and/or references to complete font files or segments of font files. By way of example, a font-file stream could return a reference to a memory-mapped segment of a font file in response to a request for a font. The use of references to memory-mapped segments of font files permits applications to avoid loading entire font files into memory, which font files, as previously stated, may be quite large. According to an embodiment of the invention, font-file loaders maintain lists of font-file keys for which font-file streams can be created for applications to use to access font files. According to a further embodiment of the invention, a font-file loader can use a given font-file key to create a font-file stream, the font-file keys containing information that facilitates the creation of said font-file stream. Font-file streams allow applications to access font files in a variety of locations without knowing specific access details. This allows applications to use a single font-file access mechanism to access all font files regardless of the method of storage of the actual font file.

Accordingly, in embodiments, the present invention is directed to one or more computer-readable storage media having computer-executable instructions embodied thereon for performing a method of loading a font file. The method includes requesting the font file, receiving a font-file stream and, using a processor, loading the font file using the font-file stream. The font-file stream is associated with the font file. In one embodiment, requesting the font file may include communicating a font-file-loader identifier to a font-file-loader manager, receiving a handle of a font-file loader associated with the font-file-loader identifier, and requesting the font file from the font-file loader. In another embodiment, requesting the font file may include communicating a font-file key to a font cache. The method further includes rendering at least a portion of the font file in association with a computing device.

In another embodiment, the present invention is directed to a computer-implemented method of loading a font file. The method includes receiving a handle associated with a font-file loader, the font-file loader being associated with the font file. The method further includes requesting the font file from the font-file loader using a first computer process, wherein the font file is associated with a font-file key, and receiving a font-file stream from the font-file loader, the font-file stream being associated with the font file. Still further, the method includes, using a second computer process, requesting a segment of the font file using the font-file stream and receiving a reference to the requested segment of the font file. The method further includes rendering the segment of the font file in association with a computing device.

A further embodiment of the present invention is directed to a font loader for loading font files. The font loader includes a font-file-loader manager component, one or more font-file loader components and one or more font-file stream components. The font-file-loader manager component is configured to return a handle associated with a font-file loader based on a provided font-file-loader identifier. Each of the one or more font-file loaders are configured to return a font-file stream based on a provided font-file key. Each of the one or more font-file stream components are configured to return at least one segment of a font file.

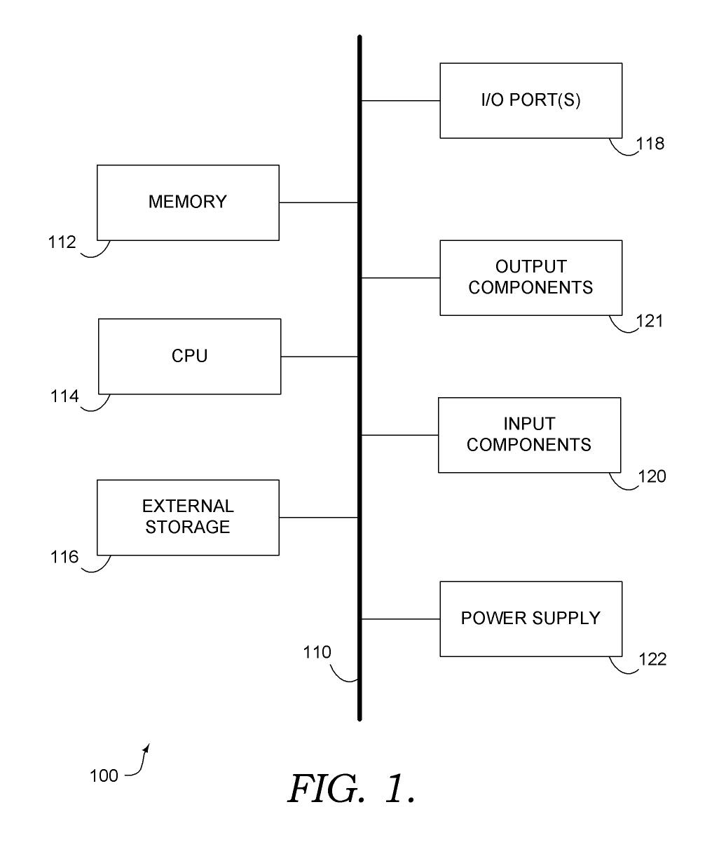

Having briefly described an overview of embodiments of the present invention, an exemplary operating environment in which embodiments of the present invention may be implemented is described below in order to provide a general context for various aspects of the present invention. With reference to FIG. 1, such exemplary operating environment is shown and designated generally as computing device 100. Computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, and the like, refer to code that perform particular tasks or implement particular abstract data types. Embodiments of the invention may be practiced in a variety of system configurations, including hand-held devices, consumer electronics, general-purpose computing devices, more specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more external storage components 116, input/output (I/O) ports 118, input components 120, output components 121, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Memory 112 includes computer-storage media in the form of volatile memory. Exemplary hardware devices include solid-state memory, such as RAM. External storage 116 includes computer-storage media in the form of non-volatile memory. The memory may be removable, non-removable, or a combination thereof. Exemplary hardware devices include solid-state memory, hard drives, optical-disc drives, and the like. Computing device 100 includes one or more processors that read data from various entities such as memory 112, external storage 116 or input components 120. Output components 121 present data indications to a user or other device. Exemplary output components include a display device, speaker, printing component, vibrating component, etc.

I/O ports 118 allow computing device 100 to be logically coupled to other devices including input components 120 and output components 121, some of which may be built in. Illustrative components include a microphone, joystick, game pad, satellite dish, scanner, printer, wireless device, and the like.

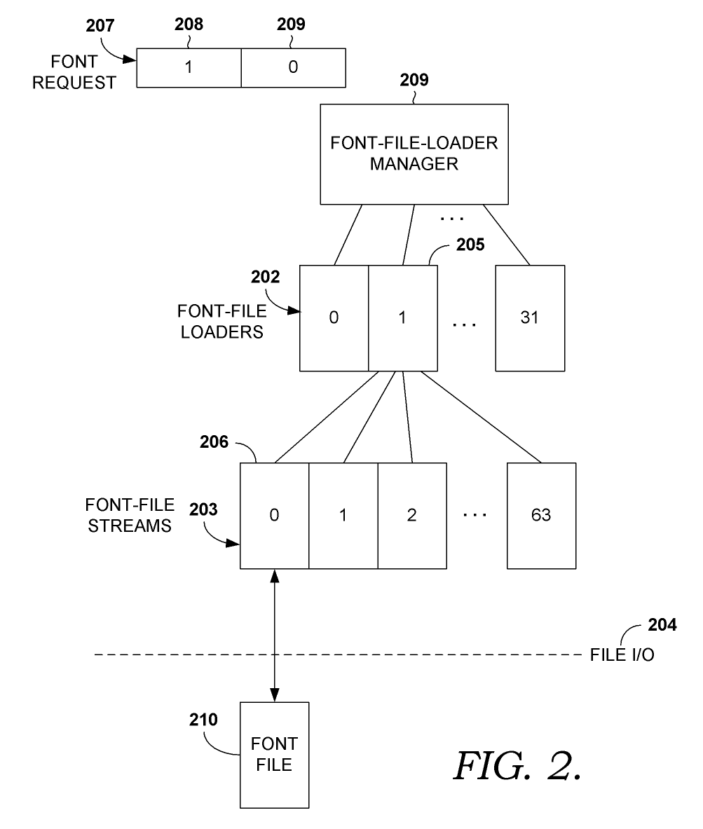

As previously stated, embodiments of the present invention are related to extensible font file loading. According to some embodiments, font files or portions of font files may be loaded using a multi-component architecture. Turning now to FIG. 2, an example of loading a font file is depicted. FIG. 2 depicts, in part, a font loader system comprised of three components: a font-file-loader manager 209, a plurality of font-file loaders 202 and a plurality of font-file streams 203. The font-file-loader manager 209 is configured to maintain a list, directory, table or the like of all available font-file loaders 202. If desired, the font-file-loader manager may assign each font-file loader 202 included in the list/directory/table of the font-file-loader manager 209 a unique font-file-loader identifier. The font-file-loader identifier may then be utilized in requests for font files to refer to the appropriate font-file loader 202 responsible for loading the desired font file, as more fully described below.

Font-file streams are managed by corresponding font-file loaders. Thus, according to embodiments of the invention, each of the font-file loaders 202 maintains a list, directory, table, or the like containing all of the font-keys for which it has created font-file streams 203. By way of example, each font-file loader 202 is responsible for creating and maintaining a number of font-file streams 203, each stream having a font-file keys that is associated with said single font-file stream 203. Each font file stream 203 is, in turn, associated with a font file 210. The font-file streams 203 have access methods to their respective font files 210 using an appropriate file I/O interface 204 for the particular font file 210.

By way of example, consider a font request 207 for a font file 210 issued by an application. The request includes a two part identifier, identifying the desired font file. The first part 208 contains a font-file-loader identifier and the second part 209 contains a font-file key. The font-file-loader manager 209 receives the font request 207 and uses the font-file-loader identifier 208 to locate the appropriate font-file loader 205. The font-file loader 205 uses the appropriate font-file key to identify or create the font-file stream 206 associated with the desired font file 210. The application may then utilize the font-file stream 206 to read data from the font file 210 without using any specific access methods related to the file system I/O interface 204.

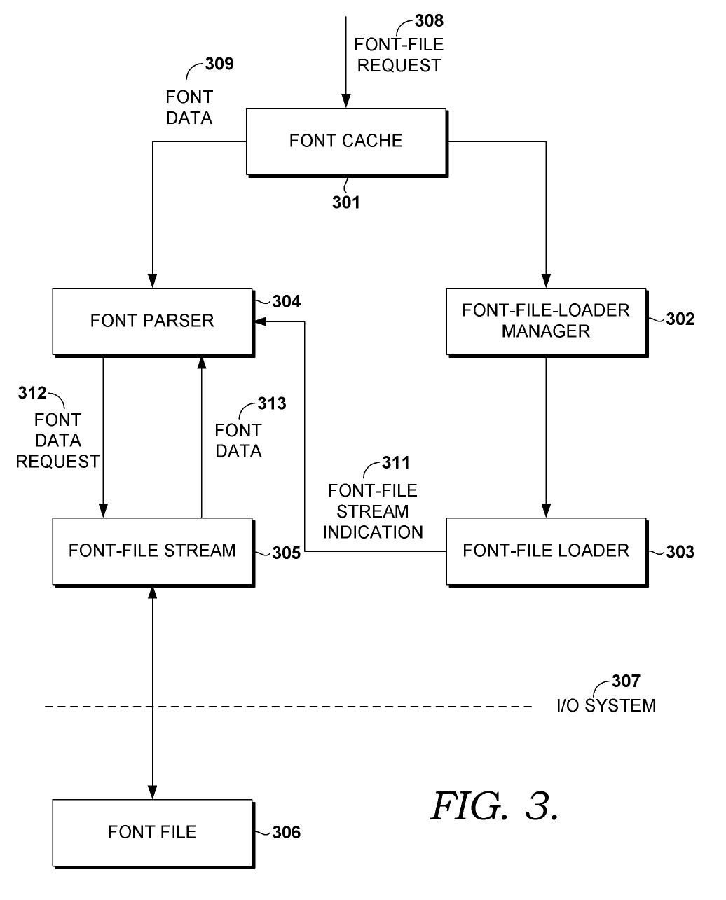

Turning now to FIG. 3, a block diagram of a font-loading system, in accordance with an embodiment of the present invention is illustrated. In accordance with the embodiment of FIG. 3, a font-file-loader manager may be integrated into a font loading system to provide access to font files. A font-file request 308 for a particular font file 306 is received by a font cache 301. If the font cache 301 already has a handle to the appropriate font-file stream 305 associated with the requested font file 306 stored in association therewith, the font cache 301 passes the font data 309 to a font parser 304. By way of example, a font-file key could be passed to the font-file cache 301 that uniquely identifies font data that is requested for rendering.

If, however, the font cache 301 does not have a the font data associated with the requested font file 306 stored in association therewith, the font-file request 308 is instead forwarded to a font-file-loader manager 302. As stated herein above, font-file request 308 (like font file request 207 of FIG. 2), includes a two part identifier for the desired font file: a font-file-loader identifier and a font-file key. Thus, in accordance with one embodiment of the invention, the font-file-loader manager 302 identifies the font-file loader 303 responsible for the font-file stream 305 associated with the desired font file 306 using the font-file-loader identifier contained in the font-file request 308. The identified font-file loader 303 then locates the font-file stream 305 associated with the desired font file 306 using the font-file key contained in the font-file request 308. The font-file loader 303 passes a handle to the font-file stream 305 (or font-file stream indication 311) to the font parser 304.

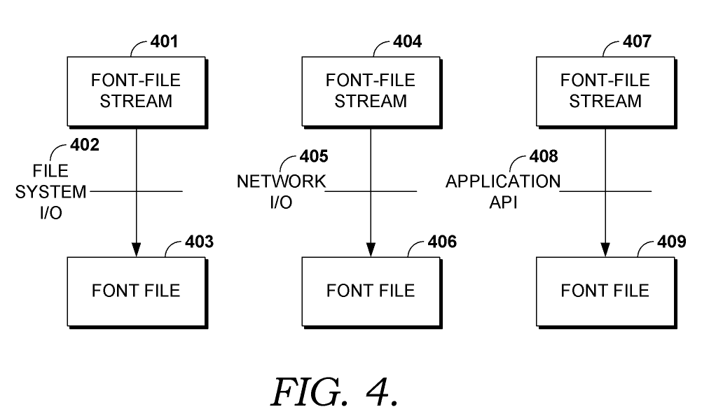

Once the appropriate handle or font-file stream indication 309 or 311 has been received by the font parser 304, the font parser 304 accesses the font file 306 using the appropriate font-file stream 305. By way of example, the font-file stream 305 may expose a group of methods for use by the font parser 304 for accessing the font file 306. These methods may include reading a segment of the font file 306, seeking within the font file 306, loading the entire font file 306, and/or requesting a specific character or amount of data from the font file 306. Using these methods, the font parser 304 formulates a font data request 312 for at least a portion of the font file 306 and passes the request 312 to the font-file stream 305. The font-file stream 305 then accesses the appropriate data from the font file 306, as more fully described below with reference to FIG. 4. The font-file stream 305 then returns the accessed font data 313 to the font parser 304. According to one embodiment of the invention, the font data 313 includes data segments from the font file 306. According to another embodiment, the font data 313 includes references to data from the font file 306

The font-file stream 305 allows the font parser 304 to access the font file 306 without the font parser 304 knowing the details of the I/O system 307 through which the font file 306 is accessed. Turning to FIG. 4, a block diagram depicting various I/O system interfaces to font files is illustrated. In a first example, a font-file stream 401 utilizes a file-system I/O interface 402 to access a font file 403. Such a file system I/O interface could include local file systems such as NTFS, ext3, ext2, and FAT, and remote file systems such as NFS and SAMBA. Those skilled in the art will recognize that there are many file system I/O types 402 that could be used to access a font file 403 and embodiments of the present invention are not intended to be limited by any particular file system I/O interface. In another example, a font-file stream 404 could use a network I/O interface 405 to access a font file 406. Such a network I/O interface 405 could include HTTP and FTP. Those skilled in the art will recognize that there are many network I/O interfaces that could be used to access a font file and embodiments of the present invention are not intended to be limited by any particular network 10 interface 405. In yet another example, a font-file stream 407 could use an application-specific application programming interface (API) 408 to access a font file 409. Such application-specific APIs 408 can be implemented by each application and allow the access of font-file data embedded within a particular application. Those skilled in the art will recognize that, by using font-file streams to handle the specific details of font-file access, new font files can be added to the system without the need to modify the font parsers or applications using the font files, since the interface between the font-file streams and the font parser or the applications remains unchanged.

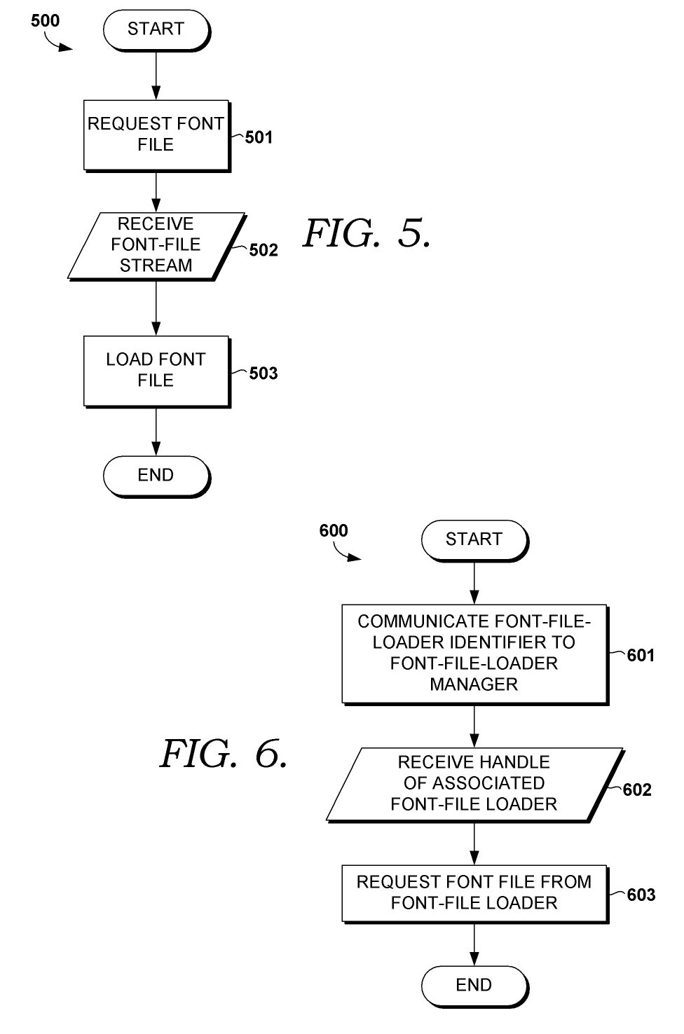

Referring now to FIG. 5, a flow diagram is provided that illustrates a method 500 of loading a font file in accordance with an embodiment of the present invention. Initially, as indicated at block 501, a request for a font file is sent. In embodiments, the request includes a font-file-loader identifier and a font-file key. Those skilled in the art will recognize that the format of the request and of the font-file-loader identifier and font-file key could take many forms. By way of example and not limitation, the request could contain multiple fields, including a field containing an integer representing a font-file-loader identifier and a field containing a string representing a font-file key.

As indicated at block 502, a font-file stream is received for use in accessing the font file. By way of example, a handle associated with a font-file stream may be received for use in accessing functions provided by the font-file stream to load information from the font file. Those skilled in the art will recognize that there are many ways in which a font-file stream could be received, including, without limitation, passing the object implementing the font-file stream and passing a reference to the font-file stream.

Next, the requested font file data is loaded, as shown at block 503. Loading the font file data can include retrieving only a segment of the font file and retrieving the entire font file. According to some embodiments of the invention, the font file data is retrieved using a reference to a memory-mapped portion of the font file. The retrieved font file, or appropriate portion thereof, may then be utilized to render the appropriate font, for instance, in association with a computing device presentation component (e.g. a monitor).

According to an embodiment, requesting a font file, as shown at block 501 in FIG. 5, may involve communicating with a font-file-loader manager and a font-file loader. Such an embodiment is illustrated with reference to FIG. 6. As shown at block 601, a font-file-loader identifier is communicated to a font-file-loader manager. The font-file-loader identifier can uniquely identify a font-file loader responsible for maintaining the font-file stream associated with the desired font file. As shown at block 602, the font-file-loader manager returns a handle associated with the appropriate a font-file loader. The font file, or at least a portion thereof, is then requested from the font-file loader, as shown at block 603. By way of example, requesting the font file (or portion thereof) from the font-file loader can include using a font-file key to identify an appropriate font file. In one example, the font-file key may uniquely identify the appropriate font file within the font-file loader. As another example, the font-file key may uniquely identify a font-file stream associated with the desired font file, within the font file loader. Any and all such variations, and any combination thereof, are contemplated to be within the scope of embodiments of the present invention.

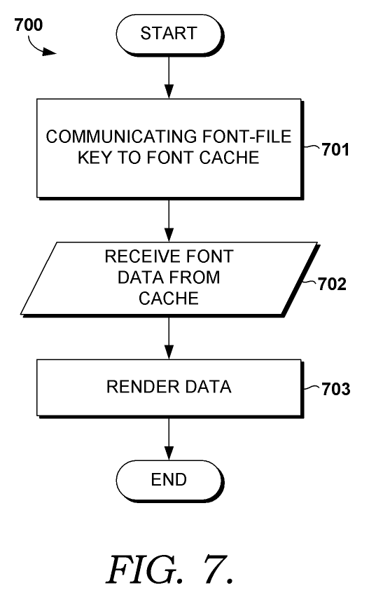

Referring now to FIG. 7, according to another embodiment, requesting a font file, as shown in at block 501 in FIG. 5, may involve communicating with a font cache. A font-file key are communicated to a font cache, as shown at block 701. By way of example, the font-file key may be utilized to create a unique identifier for each of one or more font data segments stored in the font cache. The font cache may then utilize the font-file key to locate font data associated with the font file requested. The font data is received from the cache, as shown at block 702 and the font data could be rendered, as shown at 703. There are many ways in which font data could be rendered. For example, a font parser could be used to prepare font data to be passed to a display device for rendering. As another example, the font data could be rendered by a printing device. Any and all such variations, and any combination thereof, are contemplated to be within the scope of embodiments of the present invention.

According to some embodiments of the invention, a font request will be sent to a font cache. If font data associated with the requested font file is not found in the font cache, then the font-file request is communicated to a font-file-loader manager. Accordingly, the font cache may forward the font-file request to the font-file-loader manager upon failing to locate a font-file stream associated with the requested font file. Alternatively, the font cache may report the failure to the requestor of the font file and the requester could choose to request the font file from the font-file-loader manager. Any and all such variations, and any combination thereof, are contemplated to be within the scope of embodiments hereof.

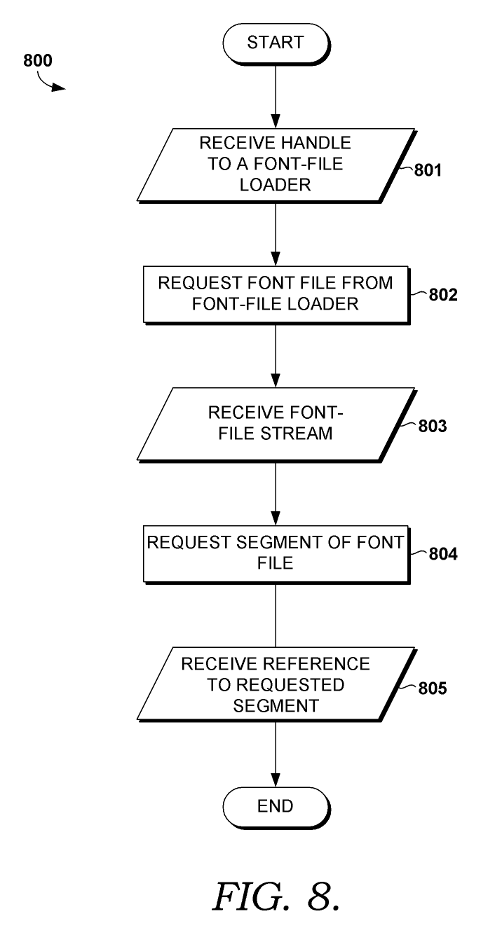

Turning now to FIG. 8, a flow diagram depicting a method of loading a font file using a font-file loader is shown. Initially, as indicated at block 801, a handle to a font-file loader is received. According to an embodiment, the handle is received from a font-file-loader manager. Those skilled in the art will recognize that there are other ways to deliver a handle to a font-file loader, including, without limitation, requesting a handle to a font-file loader from a font cache and retrieving a handle to a font-file loader from an internal list (e.g. an application-specific list). Next, as indicated at block 802, a font file is requested from the font-file loader. By way of example, the handle may include a function call used to request a font file by specifying a font-file key. A font-file stream is received, as indicated at block 803. According to some embodiments, the font-file stream is associated with a font file and provides access functions for use by a font parser or other application needing the font file data. The font-file stream can hide the complexity of specific access functions needed to access data contained in specific font files. By way of example, specific file system call details could be encapsulated by one font-file stream while specific network calls to access a remote font file could be encapsulated by another font-file stream. Both the example font-file streams, however, could expose the same access interface to the font parser or other application that requested the font file. In this way, new font files can be easily added to the font system, regardless of their specific implementation and storage/access mechanisms.

A segment of the font file is requested via the font-file stream, as shown at block 804. According to an embodiment of the invention, a segment of a font file can be requested, where the segment provides only enough information to render a subset of characters using the desired font. By way of example, the segment may contain header information about the font and information needed to render a single character. As another example, the segment may contain enough information to render a paragraph of characters. Additionally, a segment may be an improper subset of the set of characters defined in the font file (e.g. the segment may contain the entire font file). Any and all such variations, and any combination thereof, are contemplated to be within the scope of embodiments of the present invention. According to another embodiment of the invention, the font-file stream provides random access to the font file.

A reference to the requested segment is received, as shown at block 805. According to an embodiment of the invention, the reference to the requested segment can be a reference to a memory-mapped segment of the font file. Those skilled in the are will recognize that there are many other forms in which the reference could take place. By way of example, the reference could be the address of a memory segment into which the relevant segment of the font file was loaded. As another example, the reference could be an address offset into a location into which the entire font file was loaded. any and all such variations, and any combination thereof, are contemplated to be within the scope of embodiments of the present invention.

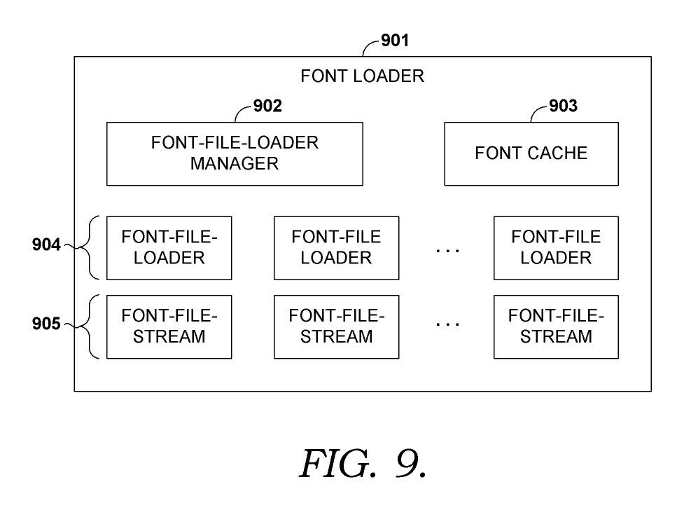

Referring to FIG. 9, a block diagram of the font loader system is illustrated and designated generally as reference numeral 901. Font loader system 901 includes a font-file-loader manager component 902, a plurality of font-file loader components 904, and one or more font-file stream component 905. The font-file-loader manager component 902 is configured to return a handle associated with a font-file loader (i.e., one of font-file loaders 904), given an associated font-file-loader identifier. According to an embodiment, the font-file-loader manager component 902 may also be configured to assign unique font-file-loader identifiers to new font-file loaders that are added to the system.

The font-file-loader component(s) 904 are each configured to return a handle to a font-file stream that is associated with a desired font file. The font files can be identified by a unique font-file key. According to an embodiment, the font-file loader components 904 are also configured to assign unique identifiers to newly added font files. According to another embodiment, the font-file loaders 904 are configured to create font-file streams associated with newly added font files. According to a further embodiment, font-file streams are created dynamically based on font-file keys uniquely identifying font files.

The font-file stream component(s) 905 are configured to expose a means of access to a font file. By way of example, the exposed means of access could be an API, which provides a common access interface to font files, regardless of the low-level access methods used to load the font files (e.g. file-system access methods, network access methods, embedded-application access methods). According to some embodiments of the invention, the font-file streams 905 are configured to return references to segments of the associated font file. By way of example, the reference to a segment could be a reference to a memory-mapped portion of the font file containing the information to render a subset of characters.

In the illustrated embodiment, the font loader system 901 contains a font cache component 903. The font cache component 903 is configured to store one or more font data segments, each associated with a font-file key. The font cache component 903 may also be configure to return a handle to a font-file stream in response to a request for a font file containing a font-file-loader identifier and a font-file key. According to some embodiments, a font cache component 903 can be configured to forward any font-file request to a font-file-loader manager for which the font cache 903 does not have a stored font-file stream.

As can be understood, embodiments of the present invention are directed to extensible loading of font files. Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and sub-combinations are of utility and may be employed without reference to other features and sub-combinations and are contemplated within the scope of the claims. Not all steps listed in the various figures need be carried out in the specific order described.

The invention claimed is:

1. One or more computer-readable storage media having computer-executable instructions embodied thereon for performing a method of loading a font file, the method comprising:
requesting the font file;
receiving a font-file stream, wherein the font-file stream is associated with the font file;
using a processor, loading the font file using the font-file stream; and
rendering at least a portion of the font file in association with a computing device.

2. The media of claim 1, wherein requesting a font file comprises:
communicating a font-file-loader identifier to a font-file-loader manager;
receiving a handle of a font-file loader associated with the font-file-loader identifier; and
requesting the font file from the font-file loader.

3. The media of claim 1, wherein requesting the font file comprises communicating a font-file key to a font cache.

4. The media of claim 2, wherein requesting the font file from the font-file loader comprises communicating a font-file key to the font-file loader.

5. The media of claim 3, wherein receiving a font-file stream comprises receiving the font data from the font cache.

6. The media of claim 1, wherein the font-file stream is associated with a font file stored on local storage.

7. The media of claim 1, wherein the font-file stream is associated with a font file stored on remote storage, wherein the remote storage is accessed by one of a plurality of remote-access protocols.

8. The media of claim 7, wherein the remote-access protocol is Hyper Text Transfer Protocol (HTTP).

9. The media of claim 1, wherein the font-file stream is associated with a font file embedded in an application.

10. The media of claim 1, wherein the font-file stream comprises an Application Programming Interface (API) for accessing the font file.

11. The media of claim 1, wherein loading the font file comprises:
requesting a segment of the font file from the font-file stream; and
receiving a reference to the segment of the font file.

12. The media of claim 11, wherein the reference to the segment of the font file comprises a reference to a memory-mapped segment of the file.

13. A computer-implemented method of loading a font file, the method comprising:
receiving a handle to a font-file loader associated with the font file;
requesting the font file from the font-file loader using a first computer process, wherein the font file is associated with a font-file key;
receiving a font-file stream from the font-file loader, wherein the font-file stream is associated with the font file;
using a second computer process, requesting a segment of the font file using the font-file stream;
receiving a reference to the requested segment of the font file; and
rendering the segment of the font file in association with a computing device.

14. The method of claim 13, wherein the font-file loader is associated with a font-file-loader identifier that uniquely identifies the font-file loader.

15. The method of claim 13, wherein the font-file key uniquely identifies the font file.

16. The method of claim 13, wherein the segment of the font file comprises a segment of the font file containing one or more characters.

17. The method of claim 13, wherein the reference to the requested segment of the font file comprises a pointer to a memory-mapped segment of the font file.

18. A font loader for loading font files, the font loader comprising:
a font-file-loader manager component configured to return a handle associated with a font-file loader based on a provided font-file-loader identifier;
one or more font-file loader components, each configured to return a font-file stream based on a provided font-file key; and
one or more font-file stream components, each configured to return at least one segment of a font file.

19. The font loader of claim 18, wherein the at least one segment of a font file is returned using references to memory-mapped segments of the font file.

20. The font loader of claim 18, wherein the font loader further comprises a font cache component configured to store a plurality of font data segments and each segment's associated font-file key, wherein the plurality of font data segments is capable of being accessed from the font cache component.
